(19) United States
(12) Patent Application Publication
(10) Pub. No.: US 2026/0274318 A1
(43) Pub. Date: Sep. 17, 2026

(54) LOGISTICS MODULE WITH SHELVES

(71) Applicant: YTHALES INVEST, LA RICHE (FR)

(72) Inventor: Franck DAGON, Parcay-sur-Vienne (FR)

(21) Appl. No.: 19/167,090

(22) PCT Filed: Mar. 22, 2024
(86) PCT No.: PCT/EP2024/057869

§ 371 Date: Sep. 19, 2025

(30) Foreign Application Priority Data
Mar. 22, 2023 (FR) FR2302685

(51) Int. Cl. B62B 3/02; B62B 3/00; B62B 3/06; B62B 3/18

(52) U.S. Cl. CPC B62B 3/025; B62B 3/005; B62B 3/0625; B62B 3/0637; B62B 3/0643; B62B 3/186; B62B 2205/33; B62B 2301/12

(57) ABSTRACT

In a logistics module, an upper shelf and a lower shelf are slidably coupled to a frame. A set of stop members defines a lower end position and an upper end position between which the upper shelf can slide. The set of stop members also defines an upper end position and a lower end position between which the lower shelf can slide. The upper end position of the lower shelf is lower than the lower end position of the upper shelf. A coupling mechanism causes the lower shelf to slide downward and the upper shelf to slide upward when a load supported by the lower shelf exceeds a tipping threshold. Conversely, the coupling mechanism causes the lower shelf to slide upward and the upper shelf to slide downward when the load supported by the lower shelf falls below a tipping threshold relative to the load supported by the upper shelf.

### CROSS-REFERENCE TO RELATED APPLICATION(S)

This is a National Stage Entry into the United States Patent and Trademark Office from International Patent Application No. PCT/EP2024/057869, filed on Mar. 22, 2024, which relies on and claims priority to French Patent Application No. 2302685, filed on Mar. 22, 2023, the entire contents both of of which are incorporated herein by reference.

### FIELD OF THE INVENTION

One aspect of the invention relates to a logistics module with shelves on which objects may be placed. The logistics module may, for example, be of the type used for transporting goods, in particular a roll container. The logistics module may therefore be used, for example, to transport goods to stores for supply purposes.

### BACKGROUND OF THE INVENTION

Containers, in particular roll containers, are commonly used to transport goods to stores for restocking. At a logistics platform, these containers are filled with goods to be transported. The containers filled with goods are then placed in the cargo space of a transport vehicle, typically a truck. When the truck arrives at the destination store, the containers containing the goods intended for that store are removed from the truck's cargo space. Containers still filled with goods may be temporarily stored in a warehouse at the store. Then, one or more of these containers may be removed from the warehouse to be transported to shelves to be filled with the goods they contain.

There are many aspects to using containers as described above, including ergonomics and economy. Ergonomics come into play when loading and unloading containers. These operations are generally carried out manually by individuals, known as operators. When goods need to be placed at a relatively low height, for example, close to the ground, the operator may have to bend down. When goods need to be placed at a relatively high height, the operator may have to raise their arms above their shoulders. These body movements are tiring and wear out the body, which may lead to medical problems.

The economic aspect is particularly relevant when transporting goods by truck or another vehicle. In order to make transport as economical as possible, it is desirable that the cargo space be filled as much as possible with goods when leaving the logistics platform. This is because the cost of transport can be attributed in part to each item of goods transported. The more the cargo space is filled with goods, the lower the transport cost per item of goods transported will be. Therefore, in order to achieve a high cargo space fill rate, containers are generally filled completely with goods, or at least almost completely.

However, even when containers are completely filled, the cargo space is not necessarily fully utilized, or even nearly fully utilized. When containers are significantly shorter than the cargo space, the upper part of the cargo space remains empty and unused. In practice, this is usually the case, mainly due to the following reasons. The height of a truck's cargo space is typically between 2.20 m and 2.50 m. In contrast, the height of roll-off containers is typically around 1.80 m for ergonomic reasons. This is because if the container is too high in relation to the operator's arms, the operator will have difficulty filling the container completely. For example, they would have to raise their arms excessively or use a stepladder or similar tool to fill the upper part of the container.

Patent publication FR2899782 addresses the ergonomic aspect of a shelving storage device. This device comprises a parallelepiped frame that houses a rigid lower box and a deformable upper box. Each of these boxes comprises at least one shelf. When there are no products stored in the boxes, the upper deformable box is in a retracted position. As products are gradually loaded into the lower rigid box, it slides down gradually. The upper deformable box then gradually moves into an extended position. This makes a shelf in the upper deformable box accessible.

### SUMMARY OF THE INVENTION

There is a need for an improved logistics module that allows goods to be transported in an ergonomic and economical manner.

One aspect of the invention provides a logistics module comprising:
a frame;
an upper shelf slidably coupled to the frame;
a lower shelf slidably coupled to the frame;
a set of stop members defining a lower end position and an upper end position between which the upper shelf can slide, and defining an upper end position and a lower end position between which the lower shelf can slide, the upper end position of the lower shelf being lower than the lower end position of the upper shelf, and
a coupling mechanism causing the lower shelf to slide downwards and the upper shelf to slide upwards when a load supported by the lower shelf exceeds a tipping threshold relative to a load supported by the upper shelf and, conversely, causing the lower shelf to slide upward and the upper shelf to slide downward when the load supported by the lower shelf falls below a tipping threshold relative to the load supported by the upper shelf.

In order to load the logistics module defined above, an operator may begin stacking goods on the upper shelf, which may be located at an ergonomic height. The operator may thus load the upper shelf with goods up to a height that remains ergonomic. The operator may then begin stacking goods on the lower shelf, which may also be at an ergonomic height. The lower shelf thus supports an increasingly heavy load as it is loaded. At a certain point, the load supported by the lower shelf exceeds the tipping threshold in relation to the load supported by the upper shelf. This causes a mechanical tilting movement: the lower shelf slides downwards and the upper shelf slides upwards.

The fact that the upper shelf slides upward has two consequences. The first consequence is that the goods on this shelf are raised to a greater height, which the operator would not necessarily have been able to stack ergonomically. The second consequence is that space is freed up in the logistics module at the ergonomic height where the upper shelf was located when it was loaded. This freed-up space is then available again for loading goods into the logistics module. The fact that the lower shelf slides down has a similar consequence: more space is available to store goods on the lower shelf. In addition, as the lower shelf has been lowered with the goods already on it, a new loading height is available for the operator, which may also be ergonomic.

In order to unload the logistics module filled with goods, the reverse procedure applies. An operator may begin removing goods stacked on the lower shelf. The goods at the top of this stack may be at an ergonomic height. The lower shelf supports a progressively lighter load as it is unloaded. At a certain point, the load supported by the lower shelf falls below the tipping threshold in relation to the load supported by the upper shelf. This causes a mechanical movement that is the reverse of that mentioned hereinbefore: the lower shelf slides down and the upper shelf slides up.

The fact that the lower shelf slides upward has two consequences. The first consequence is that the goods still present on this shelf are raised to a height that may be more ergonomic for removal. The second consequence is that the goods stacked on the upper shelf are lowered to a height that may also be ergonomic for removal. The operator may therefore continue to ergonomically remove all the goods still remaining in the logistics module.

In summary, the logistics module defined above may therefore be efficiently filled with goods to a height only slightly less than that of a cargo space, while allowing for ergonomic loading and unloading of goods. As a result, the logistics module allows for a high loading rate of the cargo space in an ergonomic manner. In addition, ergonomic loading and unloading does not require any special tools, which would entail additional costs. The logistics module defined above thus enables goods to be transported ergonomically and economically.

In one embodiment, the lower end position of the upper shelf is at a height between 1.00 m and 1.50 m.

In one embodiment, the upper end position of the lower shelf is at a height between 1.40 m and 0.50 m.

In one embodiment, the upper end position of the upper shelf is at a height between 1.50 m and 2.50 m.

In one embodiment, at least one of the stop members is attached to the frame.

In one embodiment, at least one of the stop members comprises a damping device adapted to dampen the arrival of one of the following shelves, the upper shelf and the lower shelf, at its lower end position.

In one embodiment, the upper shelf, the lower shelf, and the coupling mechanism are arranged such that the upper shelf is in its lower end position and the lower shelf is in its upper end position in the absence of a load on the lower shelf.

In one embodiment, the logistics module includes a visual indicator located above the lower end position of the upper shelf, the visual indicator indicating a maximum fill level of the upper shelf.

In one embodiment, the logistics module comprises:
an openable side through which the upper shelf can be loaded; and
a fall-protection flap adapted to cover at least part of the openable side of the logistics module.

In one embodiment, the fall-prevention flap covers a portion of the openable side between the upper end position of the upper shelf and an upper edge of the openable side.

In one embodiment, the fall-prevention flap includes the visual indicator.

In one embodiment, the frame includes a pair of guide rails adapted to jointly retain the upper shelf and the lower shelf in a sliding manner.

In one embodiment, the coupling mechanism includes a link between the upper shelf and the lower shelf and a pulley through which the link passes.

In one embodiment, the upper shelf has a greater weight than the lower shelf such that the upper shelf is in its lower end position and the lower shelf is in its upper end position in the absence of a load on the lower shelf.

In one embodiment, the upper shelf includes a ballast member.

In one embodiment, the upper shelf and the lower shelf are foldable.

In one embodiment, the logistics module is in the form of a trolley for transporting goods.

For illustrative purposes, some embodiments of the invention are described in detail with reference to the accompanying drawings. This description may disclose additional features to those mentioned hereinbefore, as well as the advantages that these additional features may provide.

### BRIEF DESCRIPTION OF THE DRAWINGS

FIG. 1 is a schematic perspective view of an embodiment of a logistics module in the form of a trolley.

FIG. 2 is a schematic perspective view of a base structure that forms part of the trolley.

FIG. 3 is a schematic perspective view of the upper part of the base structure after removal of a lintel.

FIG. 4 is a schematic perspective view of a small part of the base structure near a shelf.

FIG. 5 is a schematic perspective view of the trolley at a first intermediate stage of a loading operation.

FIG. 6 is a schematic perspective view of the trolley at a second intermediate stage of the loading operation.

FIG. 7 is a schematic perspective view of the cart in a third intermediate stage of the loading operation.

FIG. 8 is a schematic perspective view of the trolley in a final stage of the loading operation.

FIG. 9 is a schematic perspective view of the trolley equipped with a fall-prevention flap covering an upper part of an open side thereof.

FIG. 10 is a schematic perspective view of an alternative base structure.

### DESCRIPTION OF EMBODIMENT(S) OF THE INVENTION

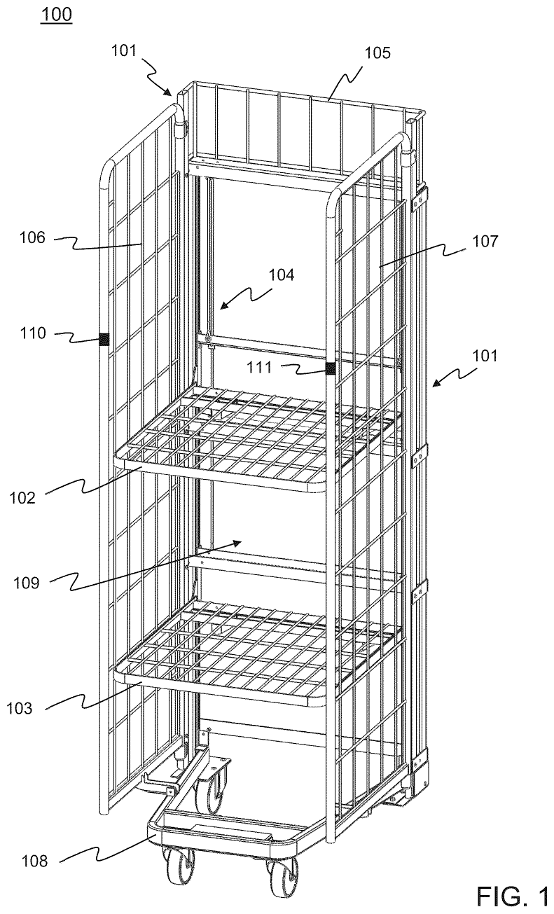

FIG. 1 schematically illustrates an embodiment of a logistics module 100 in the form of a roll container trolley. FIG. 1 shows a schematic perspective view of this embodiment 100, which will hereinafter be referred to as trolley 100 for ease of reading. The trolley 100 is particularly suitable for transporting goods, for example, from a logistics platform to a store, as well as for transporting goods to shelves within the store in order to stock them.

The trolley 100 may have the following dimensions: a width between 60 cm and 80 cm, a depth also between 60 cm and 80 cm, and a height between 200 cm and 250 cm. The height of the trolley 100 is preferably only slightly less than that of a cargo space of a transport vehicle generally used to transport goods. This allows the cargo space to be filled to a rate that is sufficiently close to the optimum, i.e., close to 100%. However, the height of the trolley 100 must also allow it to pass through standard-sized doors in logistics warehouses and stores.

The trolley 100 comprises a frame 101 and two shelves 102, 103 coupled in a sliding manner to the frame 101. The two shelves 102, 103 may thus each slide vertically, i.e., up and down. Notwithstanding their ability to slide, one of the two shelves 102 is always furthest from the floor. This shelf will therefore be referred to as the upper shelf 102. The other shelf 103, which is always closest to the floor, will be referred to as the lower shelf 103. A coupling mechanism 104 mechanically connects the two shelves 102, 103 to each other. This coupling mechanism 104 will be described in more detail later in this description. The frame 101, the two shelves 102, 103, and the coupling mechanism 104 together constitute a base structure, which will also be described in more detail below.

The trolley 100 comprises three vertical walls 105, 106, 107 mounted on a base 108 equipped with casters. One of the three vertical walls 105 abuts the frame 101. This vertical wall 105 will be referred to as the rear wall 105 for ease of reading. The other two vertical walls 106, 107 cover two sides of the trolley 100 and will be jointly referred to as the two side panels 106, 107. The two side panels 106, 107 are each connected to the frame 101 by hinges. The two side panels 106, 107 are each in the form of a grid. One side 109 of the trolley 100 has no wall; this side 109 is therefore open. The trolley 100 may therefore be loaded and unloaded through this open side 109.

FIG. 1 illustrates the trolley 100 in an unfolded state. The trolley 100 may be folded by folding the two shelves 102, 103 against the frame 101 so that both are flush with the rear wall 105. Then, the two side panels 106, 107 may be folded down against the frame 101 so that both are also flush with the rear wall 105. Once folded, the trolley 100 may be stored with other similar trolleys, also folded, without taking up too much space. To do this, the folded trolley 100 may be engaged with another similar trolley, also folded, at the base 108.

The trolley 100 includes two visual indicators 110, 111 in this embodiment. One visual indicator 110 is located on an upright of one of the two side panels 106, delimiting the open side 109 of the trolley 100. The other visual indicator 111 is located on an upright of the other of the two side panels 107 also delimiting the open face 109 of trolley 100. These visual indicators 110, 111 have a function that will be described below. The visual indicators 110, 111 may each take the form, for example, of a contrasting colored piece attached to the upright in question, or applied to it with paint or a marker.

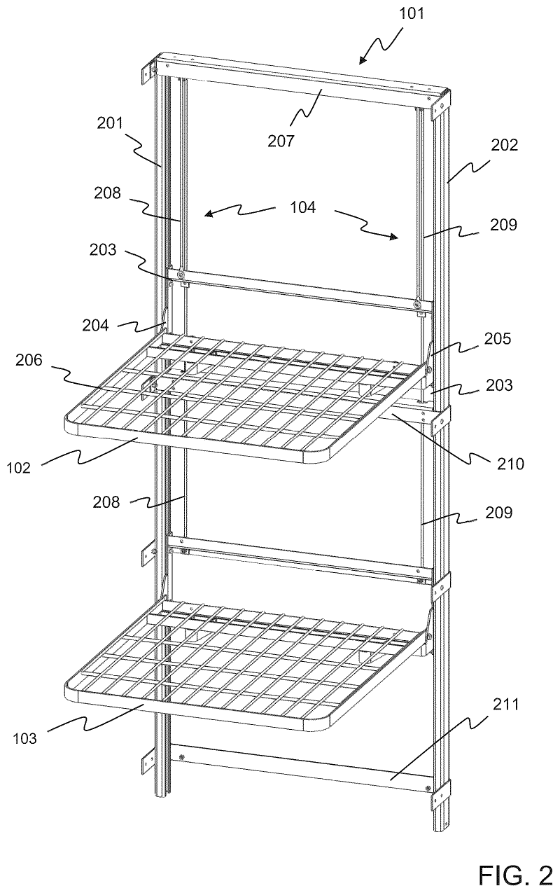

FIG. 2 schematically illustrates the basic structure of the trolley 100 mentioned hereinbefore. FIG. 2 shows a schematic perspective view of the basic structure. In this embodiment, the frame 101 includes a pair of guide rails 201, 202. This pair of guide rails 201, 202 jointly retain the upper shelf 102 and the lower shelf 103 in a sliding manner. One of the guide rails 201 will be referred to as the left guide rail 201 in the following for ease of reading. The other guide rail 202 will be referred to as the right guide rail 202.

More specifically, the upper shelf 102 comprises a support 203 equipped with a pair of runners 204, 205. One of these runners 204 engages with the left guide rail 201, while the other runner 205 engages with the right guide rail 202. A support plate 206, which forms the main part of the upper shelf 102, is rotatably attached to the support 203 equipped with the pair of runners 204, 205. The above remarks also apply to the lower shelf 103, which is of similar construction.

The coupling mechanism 104 is partially visible in FIG. 2. A lintel 207 conceals part of the coupling mechanism 104, which will be described later. In this embodiment, the coupling mechanism 104 comprises a pair of cables 208, 209. One of these cables 208 is located near the left guide rail 201. This cable will be referred to as the left cable 208 in the following. The other cable 209 is located near the right guide rail 202. This other cable will be referred to as the right cable 209 in the following.

One end of the left cable 208 is attached to the upper shelf 102 and, more specifically, to its support 203 equipped with the pair of runners 204, 205. Another end of the left cable 208 is attached to the lower shelf 103 and, more specifically, also to its support equipped with the pair of runners. Similarly, one end of the right cable 209 is attached to the upper shelf 102, while another end of the right cable 209 is attached to the lower shelf 103.

The left cable 208 and the right cable 209 each have a length that is substantially identical. This length will hereinafter be referred to as the cable length. The cable length determines a position of the upper shelf 102 relative to that of the lower shelf 103, and vice versa. Therefore, when the upper shelf 102 is at a height relative to the ground, the lower shelf 103 is at a height relative to the ground that is determined by this relationship, and vice versa. This relationship between the position of the upper shelf 102 and that of the lower shelf 103 will be discussed in more detail below.

In this embodiment, the base structure comprises two stop members 210, 211. One stop member 210 is located furthest from the floor and is situated between the upper shelf 102 and the lower shelf 103. This stop member 210 will be referred to as the upper stop member 210. The other stop member 211 is located closest to the ground and is positioned below the lower shelf 103. This stop member 211 will be referred to as the lower stop member 211. In this embodiment, the two stop members 210, 211 each comprise a crossbar extending between the guide rails 201, 202.

The upper stop member 210 defines a lower end position for the upper shelf 102. This end position may be located at a height between, for example, 1.00 m and 1.50 m from the floor and, more specifically, between 1.20 m and 1.50 m. To achieve this, the upper stop member 210 may be positioned at a height relative to the ground that is similar to, or slightly below, the end position in question. The upper stop member 210 also defines an upper end position for the lower shelf 103. This is due to the relationship between the position of the upper shelf 102 and that of the lower shelf 103 mentioned hereinbefore. The upper end position of the lower shelf 103 may be located at a height between, for example, 1.40 m and 0.50 m from the ground and, more specifically, between 1.20 m and 0.70 m.

The lower stop member 211 defines a lower end position of the lower shelf 103. This end position may be located close to the floor, slightly above the base 108 of the trolley 100. To this end, the upper stop member 210 may be positioned at a height close to the base 108 of the trolley 100 shown in FIG. 1. An element of the base 108 may also form the lower stop member 211. The lower stop member 211 also defines an upper end position of the upper shelf 102. This is also due to the relationship between the position of the upper shelf 102 and that of the lower shelf 103 mentioned hereinbefore. The upper end position of the upper shelf 102 may be at a height between, for example, 1.50 m and 2.50 m from the floor and, more specifically, between 1.80 m and 2.30 m.

The upper stop member 210 and the lower stop member 210 therefore define two sliding ranges: an upper sliding range for the upper shelf 102 and a lower sliding range for the lower shelf 103. The upper sliding range is between the lower end position and the upper end position of the upper shelf 102, defined by the upper stop member 211 and the lower stop member 210, respectively. The lower sliding range is located between the upper end position and the lower end position of the lower shelf 103, defined by the upper stop member 210 and the lower stop member 211 respectively. In any case, the upper end position of the lower shelf 103 is lower than the lower end position of the upper shelf 102. That is, the upper sliding range and the lower sliding range do not overlap in this embodiment.

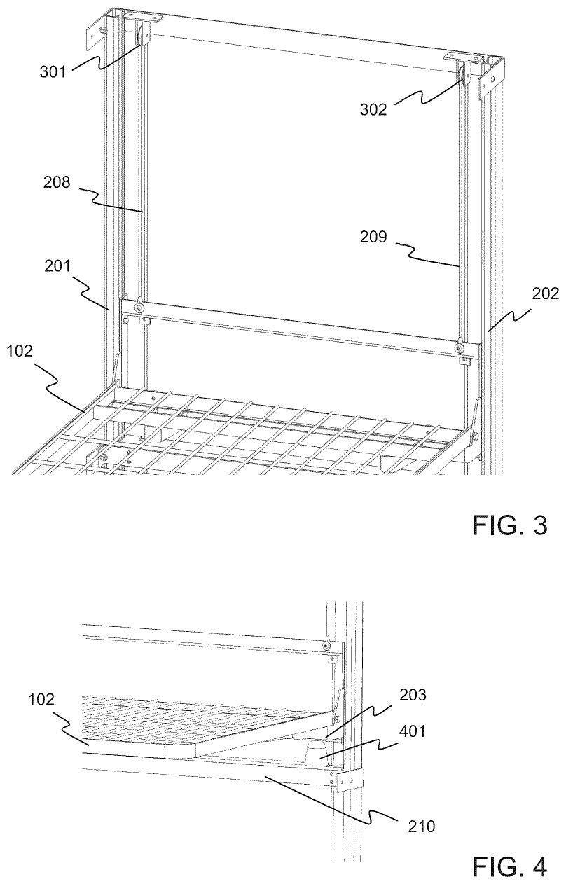

FIG. 3 schematically illustrates an upper portion of the base structure in which the lintel 207 shown in FIG. 2 has been omitted. FIG. 3 shows a schematic perspective view of the upper portion of the base structure. The upper part of the base structure includes a pair of pulleys 301, 302 that are part of the coupling mechanism 104 shown in FIG. 1. The left cable 208 passes through one of the pulleys 301. This pulley 301 will hereinafter be referred to as the left pulley 301. The right cable 209 passes through the other pulley 302, which will be referred to hereinafter as the right pulley 302. The left pulley 301 and the right pulley 302 were not visible in FIG. 2 due to the presence of the lintel 207. These pulleys 301, 302 may be attached to the lintel 207, which is located between the guide rails 201, 202 on an upper part thereof. Thus, the left pulley 301 and the right pulley 302 each have a height relative to the ground that is substantially identical. This height will hereinafter be referred to as the pulley height.

In this embodiment, the pulley height and the cable length determine the relationship between the position of the upper shelf 102 and that of the lower shelf 103 mentioned hereinbefore. Specifically, according to this relationship, the sum of the height of the upper shelf 102 relative to the ground and that of the lower shelf 103 is equal to twice the pulley height minus the cable length. Therefore, the height of the upper shelf 102 relative to the ground is equal to twice the pulley height minus the cable length minus the height of the lower shelf 103. Conversely, the height of the lower shelf 103 relative to the ground is equal to twice the pulley height minus the cable length minus the height of the upper shelf 102. Thus, in this embodiment, the pulley height and cable length are parameters that allow a satisfactory degree of ergonomics to be achieved. The same applies to the height of the upper stop member 210 and that of the lower stop member 211.

The upper shelf 102 is in its lower end position when there is no load on the lower shelf 103, as shown in FIG. 1, FIG. 2, and FIG. 3. Conversely, the lower shelf 103 is in its upper end position when there is no load on the lower shelf 103, as shown in FIG. 1 and FIG. 2. To achieve this, in this embodiment, the upper shelf 102 may have a greater weight than the lower shelf 103. The upper shelf 102 may include a ballast member so that its weight is greater than that of the lower shelf 103.

FIG. 4 schematically illustrates a small part of the basic structure near the upper shelf 203. FIG. 4 shows a schematic perspective view of this part. The upper stop member 210 is partially visible in FIG. 4, enlarged in relation to FIGS. 1-3. The upper stop member 210 includes a damping device 401. In this embodiment, the damping device 401 is in the form of a conical cylindrical part with a rounded head comprising flexible material such as rubber or elastomer. As illustrated in FIG. 4, a lower edge of the support 203 of the upper shelf 102 may abut against this flexible part.

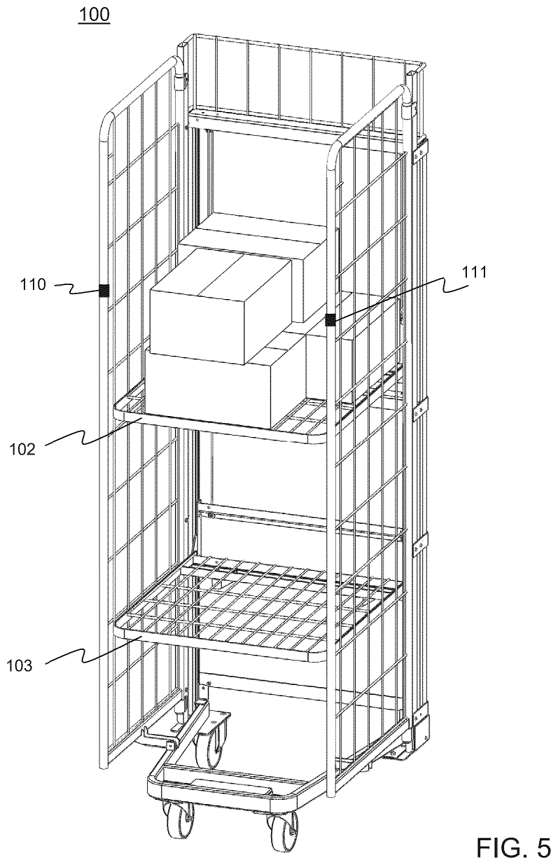

FIGS. 5-8 schematically illustrate different stages of a loading operation of the trolley 100. Each of these figures presents a schematic perspective view of the trolley 100 with goods that have been placed in the trolley 100. The loading operation may begin from the empty trolley 100 shown in FIG. 1. The upper shelf 102 is then at its lower end position while the lower shelf 103 is at its upper end position.

In a first loading step, an operator may begin stacking goods on the upper shelf 102. As indicated above, the upper shelf 102 is located at an ergonomic height. The operator may therefore begin stacking goods on the upper shelf 102 with relative ease. The upper shelf 102 remains in its lower end position while the goods are being stacked on it. The operator may continue to stack the goods on the upper shelf 102 up to a height that remains ergonomic. However, the operator may stop stacking the goods on the upper shelf when they reach a level close to the level of the visual indicators 110, 111 shown above with reference to FIG. 1.

FIG. 5 schematically illustrates a first intermediate stage of the loading operation. At this stage, the operator has finished stacking goods on the upper shelf 102, which may then receive no more goods during the loading operation in question. The upper shelf 102 is still at its lower end position at this stage. Conversely, the lower shelf 103 is at its upper end position. The operator may now begin stacking goods on the lower shelf 103. As indicated above, the lower shelf 103 is also at an ergonomic height. The operator may thus relatively easily begin stacking goods on the lower shelf 103.

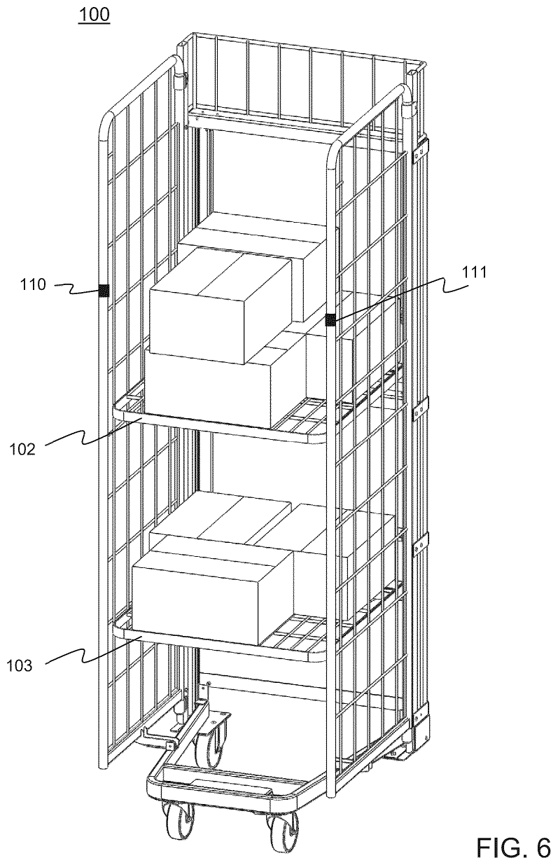

FIG. 6 schematically illustrates a second intermediate stage of the loading operation. At this stage, some goods have been placed on the lower shelf 103. These goods constitute a load supported by the lower shelf 103. However, this load is still less than the load supported by the upper shelf 102 on which goods have already been stacked. Consequently, the lower shelf 103 is still at its upper end position, while the upper shelf 102 remains at its lower end position. From the stage shown in FIG. 6, the operator may continue to stack goods on the lower shelf 103. The lower shelf 103 thus supports an increasingly heavy load as it is loaded.

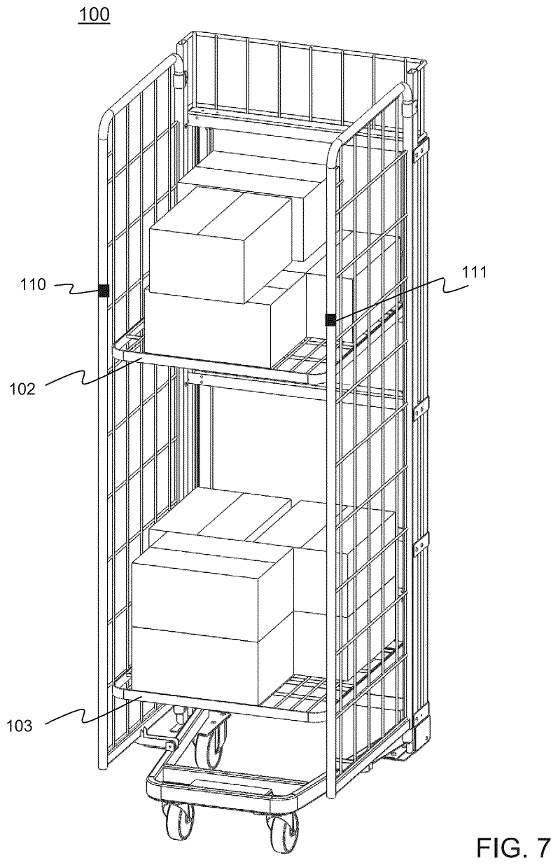

FIG. 7 schematically illustrates a third intermediate stage of the loading operation. At this stage, the load supported by the lower shelf exceeds a tipping threshold relative to the load supported by the upper shelf. This causes a mechanical tilting movement: the upper shelf 102 slides upward and the lower shelf 103 slides downward. At the stage illustrated in FIG. 7, the upper shelf 102 has a higher position relative to its lower end position without yet having reached its upper end position. Conversely, the lower shelf 103 is in a lower position relative to its upper end position without yet having reached its lower end position. The upper shelf 102 and the lower shelf 103 are thus in intermediate positions.

The fact that the upper shelf 102 slides upwards has two consequences, as illustrated in FIG. 7. The first consequence is that the goods on this shelf are raised to a greater height, at which the operator would not necessarily have been able to stack the goods ergonomically. The second consequence is that space is freed up in the logistics module at the ergonomic height where the upper shelf 102 was located when it was changed. This freed-up space is thus once again available for loading goods into the logistics module. The fact that the lower shelf 103 slides down has a similar consequence: more space is available for storing goods on the lower shelf 103. In addition, as the lower shelf 103 has been lowered with the goods already on it, a new loading height is available for the operator, which may also be ergonomic.

In this embodiment, the tipping point in question concerning the load supported by the lower shelf 103 relative to that supported by the upper shelf 102 corresponds substantially to a ratio slightly greater than 1:1 due to a difference in weight between the upper shelf 102 and the lower shelf 103. As mentioned hereinbefore, the upper shelf 102 is heavier than the lower shelf 103. The difference in weight means that, in this embodiment, when there is no load on the lower shelf 103, the upper shelf 102 is at its lower end position and, conversely, the lower shelf 103 is at its upper end position.

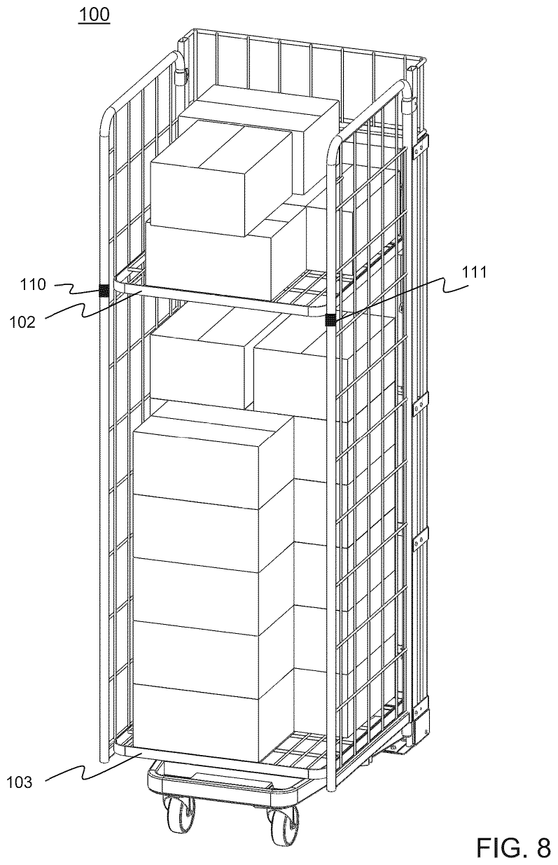

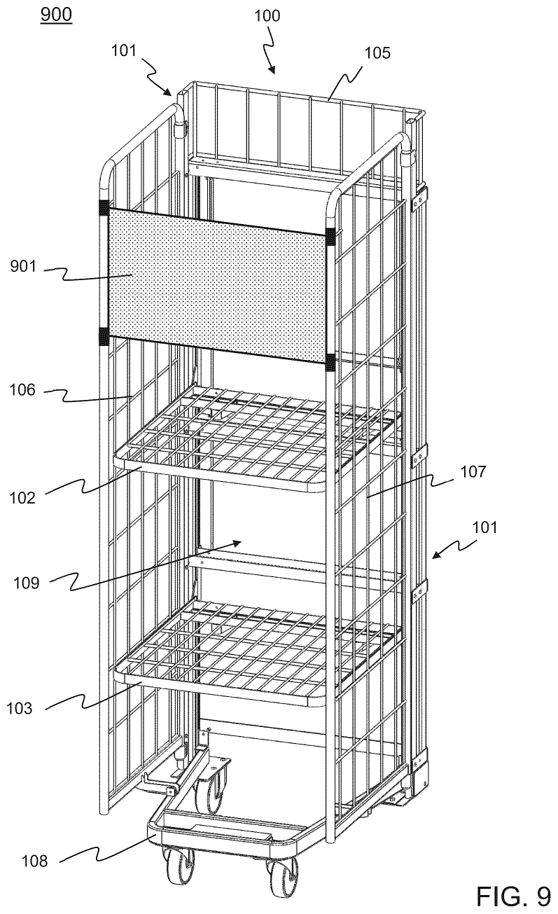

FIG. 8 schematically illustrates a final stage of the loading operation. At this stage, the operator has finished stacking the goods on the lower shelf 103. The trolley 100 is thus almost completely filled with goods, as illustrated in FIG. 8. The upper shelf 102 is then at its upper end position. Conversely, the lower shelf 103 is at its lower end position.

In order to unload the trolley 100 filled with goods shown in FIG. 8, the reverse procedure applies. An operator may begin to remove goods stacked on the lower shelf 103. The goods at the top of this stack may be at an ergonomic height. The lower shelf 103 supports a progressively lighter load as it is unloaded. At a certain point, the load supported by the lower shelf 103 falls below a tipping threshold relative to the load supported by the upper shelf 102. This has two effects: the lower shelf 103 slides upward and the upper shelf 102 slides downward.

The fact that the bottom shelf 103 slides upward has two consequences. The first consequence is that the goods still present on this shelf are raised to a height that may be more ergonomic for removal. The second consequence is that the goods stacked on the upper shelf 102 are lowered to a height that may also be ergonomic for removal. The operator may therefore continue to ergonomically remove all of the goods still remaining in the trolley 100.

In summary, the trolley 100 presented in the above illustration may therefore be efficiently filled with goods to a height only slightly less than that of a cargo space, while allowing for ergonomic loading and unloading of the goods. Consequently, trolley 100 allows a high loading rate of the cargo space to be achieved ergonomically. In addition, ergonomic loading and unloading does not require any special tools, which would entail additional costs. The trolley 100 as defined above thus allows goods to be transported ergonomically and economically.

FIG. 9 schematically illustrates a completed version 900 of the trolley 100 shown in FIG. 1. FIG. 9 shows a schematic perspective view of this completed version 900. The completed version 900 corresponds to the trolley 100 shown in FIG. 1, to which a fall-prevention flap 901 has been added. In this embodiment, the fall-prevention flap 901 covers an upper part of the open face 109 of the trolley 100. More specifically, this upper part is located substantially between the upper end position of the upper shelf 102 and an upper edge of the open face 109. Thus, when the upper shelf 102 is in its upper end position, the goods stacked on this shelf are facing the fall-prevention flap 901. The fall-prevention flap 901 thus prevents the goods stacked on the upper shelf 102 from falling off the trolley 100. This risk of falling is especially high when the trolley 100 is subjected to sudden shocks or jolts, for example when the trolley 100 is being moved or when the trolley 100 is being transported in a vehicle.

In addition, the fall-prevention flap 901 may serve as a visual indicator, replacing the two visual indicators 110, 111 on the trolley 100 shown in FIG. 1. More specifically, a lower edge of the fall-prevention flap 901 may be located at the same level as the two visual indicators 110, 111. The same may apply to a pair of lower fasteners of the fall-prevention flap 901, one of which is connected to the upright of one of the two side panels 106, the other lower fastener being connected to the other side panel 107.

The fall-prevention flap 901 may be permanently attached to the trolley 100. There is no need to manipulate the fall-prevention flap 901 to allow loading or unloading. This is because the goods on the upper shelf 102 are accessible when it is in its lower end position. The trolley 100 may include one or more other fall-prevention flaps in addition to the fall-prevention flap 901 shown in FIG. 9. Such an additional fall-prevention flap may cover another part of the open side 109 of the trolley 100 to prevent goods stacked on the lower shelf 103 from falling off the trolley 100.

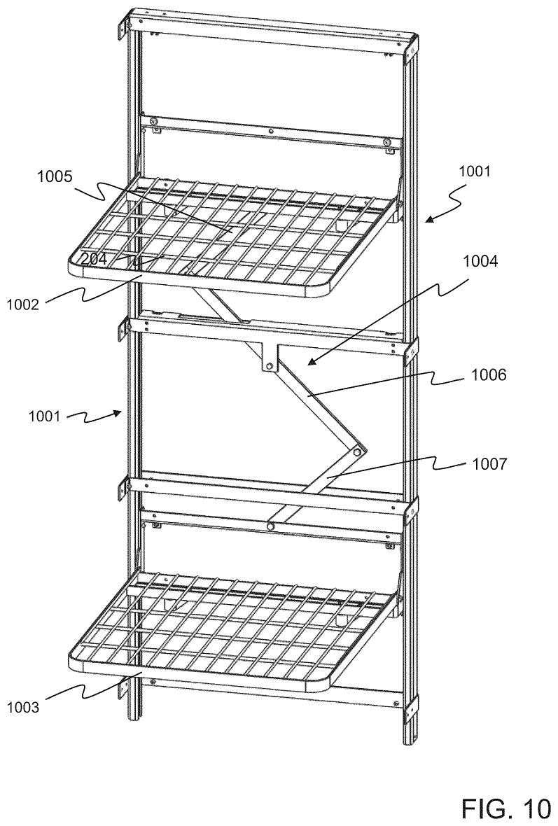

FIG. 10 schematically illustrates an alternative base structure that may replace the base structure presented above and illustrated in FIG. 2. The alternative base structure also comprises a frame 1001, an upper shelf 1002, and a lower shelf 1003. However, the alternative basic structure includes an alternative coupling mechanism 1004, which differs from that of the basic structure described hereinbefore. The alternative coupling mechanism 1004 comprises articulated linkages 1005, 1006, 1007 that form a pantograph-type system. This alternative coupling mechanism 1004 may have a similar or even identical operation to that of the coupling mechanism 104 presented above.

In fact, the basic reciprocating structure illustrated in FIG. 10 shows that there are different coupling mechanisms that allow for the transmission of movement in opposite directions. Other mechanisms may include, for example, gears, sprockets, chains, toothed wheels, toothed bars, or any combination of these elements. A coupling mechanism may also incorporate a differential, in the form, for example, of a rack-and-pinion mechanism, which causes there to be a certain ratio between movement of the upper shelf and that of the lower shelf that is not necessarily equal to one (1:1). Thus, in such an embodiment, the tipping point relating to the load supported by the lower shelf compared to that supported by the upper shelf may correspond to a ratio quite different from 1:1. For example, the ratio that causes a tilting movement may be 1:2 or 2:1, or any other ratio that is not necessarily expressed by whole numbers.

The embodiments described hereinbefore with reference to the drawings are presented for illustrative purposes. The invention may be implemented in many different ways. To illustrate this, some alternatives are briefly described.

The invention may be implemented in many types of products and processes relating to logistics. By way of illustration, an implementation has been described that relates to a trolley. Other implementations may relate to other types of logistics modules. For example, the invention may be implemented in a container, or any other module that can hold goods, not necessarily equipped with wheels. Furthermore, a logistics module according to the invention may comprise several open sides instead of just one, as is the case with the trolley presented as an illustration above. For example, the invention may be implemented in a roll-type container having four vertical sides, two of which are opposite each other and open, and two of which are also opposite each other and formed by side panels. In such an embodiment, the frame and the shelf coupling mechanism could be integrated into one of the two side panels or into both side panels with a section in each side panel.

There are many ways to implement a logistics module in accordance with the invention. In the embodiments presented, the logistics module in the form of a trolley comprises two shelves. In other embodiments, a logistics module may comprise more than two shelves. For example, a logistics module may comprise one or more stationary shelves in addition to a sliding upper shelf and a sliding lower shelf. Referring to the trolley 100 shown in FIG. 1, such a stationary shelf may be added between the upper shelf 102 and the lower shelf 103. This stationary shelf could also act as a stop and thus replace the upper stop 210. In another embodiment, a set of lower shelves could be rigidly linked together and connected by a coupling mechanism to an upper shelf according to the principle and methods already described hereinbefore. That is, referring to the trolley 100 illustrated in FIG. 1, such a set of shelves could replace the lower shelf 103 or replace the upper shelf 102.

A logistics module in accordance with the invention may comprise a spring system, or a system based on other elastically deformable components, arranged so that the lower shelf slides gradually downward when the load supported by it exceeds the tipping threshold relative to the load supported by the upper shelf. Conversely, the upper shelf will then gradually slide upward. Such a system could also provide a gradual tilting movement in the opposite direction.

A logistics module according to the invention may comprise one or more components for adjusting the tipping threshold at which a tipping movement occurs. For example, such a component may act as a brake in a track in which the shelves in question slide. Referring to the embodiment illustrated in FIG. 2, such a member may be in the form of a rubber or elastomer part that may come into contact with at least one of the runners 204 or 205 of the upper shelf 102 or those of the lower shelf 103. This contact may occur on one or more defined portions of the upper sliding range and the lower sliding range. These portions may be close to the end positions. This makes it possible to brake a tilting movement over all or part of the sliding range in question and also to adjust the tilting threshold.

As another example, an adjustment member may be in the form of a magnetic element added to, for example, a stop member. The magnetic element may exert a force on one of the shelves by magnetic attraction if the shelf is made of a material that is sensitive to magnetic attraction. This makes it possible to restrain movement of the shelf affected by this magnetic attraction and thus to adjust one of the tilt thresholds.

Such mechanisms therefore make it possible to obtain two distinct tipping thresholds. In other words, the tipping threshold at which a movement in one direction occurs may be significantly different from the tipping threshold at which a movement in the opposite direction occurs. An operator could adjust either tipping threshold by modifying, for example, the position of a component or the force it exerts. It may also be possible to define intermediate loading positions for the shelves between their lower and upper end positions defined by the stop components.

There are many ways to implement a stop member in a logistics module according to the invention. In the embodiments shown, a stop member is attached to the frame, specifically in the form of a crossbar between the slide guides. In other embodiments, a stop member may be present in the coupling mechanism. For example, referring to the pair of cables 208, 209 in the trolley 100 described by way of illustration with reference to the drawings, these cables 208, 209 may each be provided with a pair of stop members defining the upper sliding range and the lower sliding range. Such a stop member may, for example, constitute a thickening on one or other cable.

A logistics module according to the invention may comprise one or more safety devices to prevent possible accidents that may occur during its use. An accident may occur when the tipping threshold is reached during loading or unloading of the module, causing the shelves to move. In particular, an accident may occur if, at that moment, a part of the body of an operator or other person, such as their head or one of their hands, is inside the module and is struck by a moving shelf.

In a first example, a safety device comprises one or more plates mounted against one or more walls in the form of a grid. Such a plate may be transparent so that the interior of the module remains clearly visible through the grid. The plate may, for example, be made of acrylic glass. The plate prevents a hand or finger from passing through the grid and thus prevents the hand or finger from being inside the module. In this way, the plate prevents the risk of the hand or finger becoming trapped between an element of the grid and a shelf that is likely to move. The plate may be mounted on the inside. The plate then prevents part of the goods on a shelf from entering a mesh of the grid. This prevents the movement of the shelf from being blocked or the goods from being damaged, which could happen if part of them were to become lodged in a mesh of the grid.

In a second example, a safety device comprises a safety stop member and an operable mechanism that may be set to bypass the safety stop member. The safety stop member may be arranged so that a shelf set in motion after exceeding the tipping threshold may only perform a limited movement, for example a few centimeters or a few tens of centimeters. This limited movement reduces the risk of an accident and, in addition, alerts an operator that the tipping threshold has been reached and exceeded. The operator may then set the operable mechanism to bypass the safety stop. The shelf may then start moving again to reach its end position. The operator may safely accompany this movement using the operable mechanism.

In one embodiment of the second example of the safety device, the stop member may be an elongated element protruding from a guide rail, such as, for example, the left guide rail 201 or the right guide rail 202 of the logistics module 100 described hereinbefore by way of illustration with reference to the drawings. The operable mechanism that may be set to bypass this safety stop member may comprise a movable pin mounted on a shelf. This movable pin may have a default safety position and a movement release position. In the default safety position, the movable pin may come into contact with the safety stop member. The movable pin then blocks the shelf, preventing it from continuing its movement after a short initial movement following the tipping threshold being exceeded. By actioning the operable mechanism, the movable pin disengages so that it is no longer in blocking contact with the safety stop member. Accordingly, the movable pin is set to the movement release position, allowing the shelf to continue its movement until it reaches its end position. The operable mechanism may comprise, for example, a handle mounted on the shelf and a connecting rod disposed between the handle and the movable pin.

The foregoing remarks show that the embodiments described with reference to the drawings illustrate the invention rather than limit it. The reference signs are not limiting in nature. The verb “comprise” in a claim does not exclude the presence of other elements or steps than those listed in the claim. The same applies to similar verbs such as “include” and “comprise.”

1. A logistics module comprising:
a frame;
an upper shelf slidably coupled to the frame;
a lower shelf slidably coupled to the frame;
a set of stop members defining a lower end position and an upper end position between which the upper shelf can slide, and defining an upper end position and a lower end position between which the lower shelf can slide, the upper end position of the lower shelf being lower than the lower end position of the upper shelf; and
a coupling mechanism causing the lower shelf to slide downwards and the upper shelf to slide upwards when a load supported by the lower shelf exceeds a tipping threshold relative to a load supported by the upper shelf and, conversely, causing the lower shelf to slide upward and the upper shelf to slide downward when the load supported by the lower shelf falls below a tipping threshold relative to the load supported by the upper shelf.

2. The logistics module according to claim 1, wherein the lower end position of the upper shelf is at a height between 1.00 m and 1.50 m.

3. The logistics module according to claim 1, wherein the upper end position of the lower shelf is at a height between 1.40 m and 0.50 m.

4. The logistics module according to claim 1, wherein the upper end position of the upper shelf is located at a height between 1.50 m and 2.50 m.

5. The logistics module according to claim 1, wherein at least one of the stop members is attached to the frame.

6. The logistics module according to claim 1, wherein at least one of the stop members comprises a damping device adapted to dampen the arrival of one of the following shelves, the upper shelf and the lower shelf, at its lower end position.

7. The logistics module according to claim 1, wherein the upper shelf, the lower shelf, and the coupling mechanism are arranged such that the upper shelf is in its lower end position and the lower shelf is in its upper end position in the absence of a load on the lower shelf.

8. The logistics module according to claim 1, comprising a visual indicator located above the lower end position of the upper shelf, the visual indicator indicating a maximum fill level of the upper shelf.

9. The logistics module according to claim 1, comprising:
an openable side through which the upper shelf can be loaded; and
a fall-protection flap adapted to cover at least part of the openable side of the logistics module.

10. The logistics module according to claim 9, wherein the fall-prevention flap covers a portion of the openable side between the upper end position of the upper shelf and an upper edge of the openable side.

11. The logistics module according to claim 8, wherein the fall-prevention flap includes the visual indicator.

12. The logistics module according to claim 1, wherein the frame comprises a pair of guide rails adapted to jointly retain the upper shelf and the lower shelf in a sliding manner.

13. The logistics module according to claim 1, wherein the coupling mechanism comprises a link between the upper shelf and the lower shelf and a pulley through which the link passes.

14. The logistics module according to claim 13, wherein the upper shelf has a greater weight than the lower shelf such that the upper shelf is in its lower end position and the lower shelf is in its upper end position in the absence of a load on the lower shelf.

15. The logistics module according to claim 14, wherein the upper shelf comprises a ballast member.

16. The logistics module according to claim 1, wherein the upper shelf and the lower shelf are foldable.

17. The logistics module according to claim 1, wherein the logistics module is in the form of a trolley for transporting goods.
